(19) United States
(12) Patent Application Publication
(10) Pub. No.: US 2002/0059390 A1
(43) Pub. Date: May 16, 2002

(54) Integration messaging system

(75) Inventors: Steven R. Fletcher, Capistrano Beach, CA (US); John DelaTorre, Foothill Ranch, CA (US)

Correspondence Address: PATTON BOGGS, PO BOX 270930, LOUISVILLE, CO, 80027, US

(73) Assignee: Global eSoft, Inc.

(21) Appl. No.: 09/991,156

(22) Filed: Nov. 15, 2001

Related U.S. Application Data
(60) Provisional application No. 60/249,047, filed on Nov. 15, 2000.

(51) Int. Cl. G06F 15/16; G06F 17/00

(52) U.S. Cl. 709/206; 707/104.1; 709/201

(57) ABSTRACT

An integration messaging system for creating and processing customized business transactions between an originator and one or more subscribers connected to the integration messaging system via a common protocol or channel and wherein the originator selects a set of values associated with a set of data fields and associates a set of processes to a subset of the set of values. When the originator or one or more of the subscribers inserts data or changes data in one or more of the subset of the set of values, a processing device within the integration messaging system executes the customized business transaction according to one or more of the set of processes associated with the one or more of the subset of the set of values wherein data was inserted or changed.

### RELATED APPLICATIONS

This application converts U. S. Provisional Patent Application Serial No: 60/249,047 filed on Nov. 15, 2000, titled “Integrated Messaging Hub Using an SQL Database,” and which is incorporated herein by reference in its entirety, to a formal patent application titled “Integration Messaging System”.

### FIELD OF THE INVENTION

The invention relates to the field of enterprise software system integration, and in particular, to a method of integrating multiple systems using a common messaging hub that can be accessed via a variety of communication channels, and more specifically, an integration messaging system that uses customized transaction templates to provide an open and flexible messaging system to business users.

### PROBLEM

It is a problem in the field electronic messaging systems, to prevent limiting the number of businesses that can afford to implement electronically enabled transactional systems while also providing a messaging system that is flexible enough to reduce or eliminate the needs for the business to restructure their business processes in order to reap the benefits of completing transactions electronically.

There are two types of problem that arise when businesses attempt to complete transactions electronically using existing messaging systems. The first problem is integration, referred to in the art as a point-to-point integration, and the second type of problem is messaging between businesses located at different sites, referred to as business-to-business (B2B) messaging.

Messaging systems are important tools to large businesses that implement numerous business processes, complete numerous transactions and manipulate large quantities of data. The messaging systems are also important to medium and small businesses that want to compete in today's electronic business transactions. Messaging system providers map business processes that are complied into code. The code is executed on a computer system that is operated by business users to carry out business transactions. These business transaction processes are created by the messaging system provider and can not be customized by the user.

Once the business transaction has been executed, orders are sent to a plurality of vendors, partners and suppliers. Vendors, partners and suppliers that have the ability to interface directly with the messaging system have an advantage of completing transactions with the business electronically. Business transactions that are completed using electronic messaging systems result in a cost saving to the business initiating the transaction and to the vendor, partner or supplier that is a party to the transaction. However, medium and small businesses that do not have the resources to complete transactions using electronic messaging systems are at a disadvantage and large businesses initiating the transactions do not realize the same cost saving when transacting with the medium and small businesses.

As business rely on large-scale software and data applications, efforts are made to integrate best in bred applications, to make a truly enterprise wide solution. The integration of often widely disparate systems creates a number of problems. Approaches that use Application Programming Interfaces are prone to failure as one program executes a portion of the code of another application. Furthermore, there are dependencies created that can be the cause of an enterprise system crashing because of the failure of one of its component applications. Because of such problems, integrated solutions tend to fall out of synchronization, and thus the value added of the solution starts to diminish.

### Point-to-Point Integration

An integration problem occurs when an application is developed by a first vendor needs to interface with an application developed by a second vendor. When the second vendor modifies his application in such a way that the application developed by the first vendor no longer interfaces with the second interface, a system failure occurs. Since different vendors develop the first and second applications, the second vendor is not aware of the modification. To compound the problem, the failure occurs to the end user who has no control over the application developed by the first or the second vendor. The result is that the end user is required to purchase and install alternative applications.

### Business to Business Messaging

The second type of problem, referred to as a messaging problem, occurs when two or more business located at different sites need to exchange data. The first business is communicating with the second business via an inflexible interface to transfer transaction data. In this scenario each business follows a different format for internal storage of data. When a first business attempts to transact with a second business, problems occur because the format of the data to be exchanged does not match. For example, the first business may use the first data element as the business name and address. The second business may use the transaction number as the first data element and use the second data element for the business name and address. Since the formats do not match, the transaction fails.

The most common solution to the messaging problem is the use of electronic data interchange (EDI). EDI was developed to grease the wheels of commerce by facilitating rapid and frictionless exchange of business documents. Mostly these documents look more like structured databases than documents. Two problems arise when EDI is relied upon as a solution. EDI specifically deals with a set of messages developed for business-to-business (B2B) communication. These messages, referred to as transaction sets, include common business documents for vertical industries such as healthcare, finance, and government.

However, EDI has limits. EDI is too expensive and too difficult to implement and maintain, leaving it beyond the resources of small to medium size businesses. The dilemma for smaller businesses that operate and do business with larger entities is that the cost and organizational difficulties of implementing electronically enabled transactional systems often outweigh the benefits to be reaped by that investment. This negative-sum game presents a huge obstacle for these smaller entities, as well as a growing problem for their larger business partners.

EDI as a solution to the messaging problem involves strict structural requirements. Transactional documents exchanged using EDI cannot be customized. Instead, the business is required to create data mapping interfaces in order to meet the demands of the EDI application. Thus, only business that structure their organization and business processes to match the EDI application can realize the benefits of completing transactions electronically.

XML has attempted to solve the B2B problem by providing a web deployable tool. XML approached the problems present by EDI by developing a system that allowed each partner to quickly synchronize their system by exchanging not just the old structures of EDI data, but also process control templates and business rules as well. By combining the components together, XML provides a system that delivers not just data, but information accompanied by the necessary processing logic. Thus, not only is data exchanged, but also the enabling underlying processing information is exchanged. A problem with XML is its complexity. XML provides complex relationships that glue the whole XML system together. The templates are globally referenced and control and define the business context and process definitions that allow users to locate and correct components they need.

The XML system just described fails to provide a system that allows the user to define the template the user requires for transaction. Instead, XML provides a complex system that uses predetermined business process templates for performing the work. EDI and XML as solutions require the business to adapt to the structural requirements of the solution instead of providing a flexible solution that allow the business the use the solution while also maintaining their existing business processes.

For these reasons, a need exists for a solution that allows large and small business to connect and communicate via a myriad of channels that utilize disparate architectures, that is easy to use, available at a reasonable cost, and that allows the user to customize the business transaction, the information required for the transaction, and the process to complete the transaction.

### SOLUTION

The present integrated messaging hub overcomes the problems of interfacing vendors, partners and suppliers that operate on a variety of platforms and advances the art by providing a flexible enterprise business messaging system that provides a method for businesses to customize transaction templates and associate corresponding processes for completing the transaction.

### Global Link Hub

The present integration messaging system comprises a global link hub that comprises a propagation system, a messaging system, a process database, and a processing device. Within the global link hub, transaction templates are created by the business, not by the messaging system provider.

The global link hub also includes a process database that stores process instructions that are retrieved by the processing device based on changes within the active transaction. Initially, the business creates customized transaction templates by selecting data fields within propagation and messaging tables and associating one or more values to each data field.

### Interfacing with the Global Link Hub

Since almost all large-scale applications include a database as their “back end”, the knowledge of writing to and reading from, databases is within the skills required to make the application. Thus, the present integrated messaging hub simplifies talking to the messaging system. The solution also provides a method for the business user to create customized business transaction templates and processes to meet the needs of the business. Unlike prior art electronic business transaction solutions that require partners to interface via a customized interface application software, the present integrated messaging hub provides a method for partners to access the global link hub using a plurality of common protocols or channels.

### Propagation System

The propagation system comprises tables that contain data fields and values. First, the transaction originator selects a set of data fields for the transaction template then one or more values are associated with each data field. For example, if an identification data field is selected, values may be associated for the business name. Likewise, more than one value may be associated such that one value is the business name and another value is the business address, thus allowing the business that is creating the transactional document to create a customized document that resembles their non-electronic transaction documents.

Values that have triggers associated with them can also be associated with the data fields. Read data base triggers are known in the filed. A read database trigger, hereafter referred to as a trigger, monitors a specific data field for a change and is set to fire when the status of the data field is changed. As a transaction is being negotiated or processed, a specific data field and associated value may have an associated trigger. When the data inserted in the specific value changes, the associated trigger fires to initiate a process corresponding to the trigger. Once the trigger fires, a core process initiate a process associated with the specific trigger based on the value or the transition of the value associated with the data field.

Triggers continuously monitor active transaction is the payload to initiate an associated process based on the data or the transition of the data within the value. A series of predefined processes residing within a process database are associated with the specific data fields. The process is selected based first on the specific data field then on the value or the transition of the value associated with the specific data field. Therefore, the processes associated with a transaction can be customized by the data fields that are required for the transaction and by the values that are associated with the data field. Thus, providing a method for customizing the transaction template and the process followed to complete the transaction.

Once a transaction template with associated process has been created, the transaction template can be used over and over for transactions of the same type. When the transaction template is used to initiate an active transaction, the partners that the business is transacting with are selected from the partner table as subscribers to the transaction and the triggers continuously search for changes and initiate the core to execute the processes associated with the triggers until the transaction is complete. From the time that the business initiates a transaction until the originator or a subscriber associated with the transaction has completed the transaction, messaging between the parties of the transaction is provided.

### Messaging System

The messaging system located within the global link hub includes tables comprising data fields, associated values, triggers associated with changes in values and processes associated with the triggers. The functionality of the messaging tables is the same as the functionality of the transaction tables within the propagation system described above. Communication between the transaction originator and the associated subscribers, like the description for the propagation system, is dependent on the data field and the values and triggers associated with the data fields within the messaging tables.

### Integration messaging system Operation

An example of a transaction involving messaging is a transaction created by the business originator requesting quotations from two or more subscribers. When an active transaction is created it is saved in the payload table as an active transaction and a message is sent to the associated subscribers informing the subscribers that they have a message within the global link hub.

Subscribers access the active transaction within the global link hub using a variety of interface software applications connecting to the global link hub interface database. Using the data fields and associated values within the active transaction, the subscribers electronically submit quotations. Once a quotation has been inserted within a value associated with the data field, a trigger monitoring the specific data filed is fired which initiates the core process to locate and run the process associated with the specific trigger. When the transaction is complete, the completed transaction is changed from an active transaction to an inactive transaction. When a transaction is in the inactive state, the associated triggers no longer monitor the inactive transaction searching for changes, yet the inactive transaction record is available for future reference.

Thus, the present integration messaging system provides a method for business originators and business partners to communicate and complete transactions electronically without investing a large amount of capital into a customized interface software application and creating a business process that is compatible with the structured messaging solution. Instead, the present integration messaging system provides an apparatus and a method for creating customized transactions and processes for electronically completing the transactions.

### BRIEF DESCRIPTION OF THE DRAWINGS

FIG. 1 illustrates the present integrated messaging hub;

FIG. 2 illustrates the format of a table used within the global link hub;

FIG. 3 illustrates a sample of tables within the propagation system of the integrated messaging hub of FIG. 1;

FIG. 4 illustrates a process flow diagram for creating a customized transaction using the integrated messaging hub of FIG. 1;

FIG. 5 illustrates a sample of tables within the messaging system of the integrated messaging hub of FIG. 1;

FIG. 6 illustrates a process flow diagram for initiating an active transaction using the integrated messaging hub of FIG. 1; and

FIG. 7 illustrates an operational flow diagram of the present integrated messaging hub.

### DETAILED DESCRIPTION

The integration messaging system summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

Business-to-business (B2B) e-commerce has grown over the past decade in the United States. The impetus driving this growth of business transactions via electronic mediums undoubtedly is the cost savings and organizational efficiencies that can be realized by companies of all sizes through implementation of business communication technologies. Industry data points to multi-million dollar savings to be realized through more effective and comprehensive integration with suppliers, distributors and customers. Yet, the industry has largely overlooked the obstacles and challenges presented when attempting to integrate with smaller entities which have disparate and often times non-existent IT infrastructures.

The basis for electronic transactions involves creation and processing of business transactions such as purchase orders, request for purchase, invoices and quotes to name a few. The key to leveraging and extracting saving from processing transactions electronically is to allow the business transaction originator to customize transactions and to allow partners, suppliers and customers to communicate regarding the transaction or complete the transaction via a variety of communication channel interfaces. Allowing the user to customize transactions to meet his particular business needs eliminates the need to learn complex processes defined by the electronic messaging system provider or to change the environment in which the business operates.

Messaging systems are important tools to large businesses that implement numerous business processes, complete numerous transactions and manipulate large quantities of data. The messaging systems are also important to medium and small businesses that want to compete in today's electronic business transactions. Business transactions that are completed using electronic systems result in a cost saving to the business initiating the transaction and to the vendor, partner or supplier that is a party to the transaction. However, medium and small businesses that do not have the resources to complete transactions using electronic methods are at a disadvantage and large businesses initiating the transactions do not realize the same cost saving when transacting with the medium and small businesses.

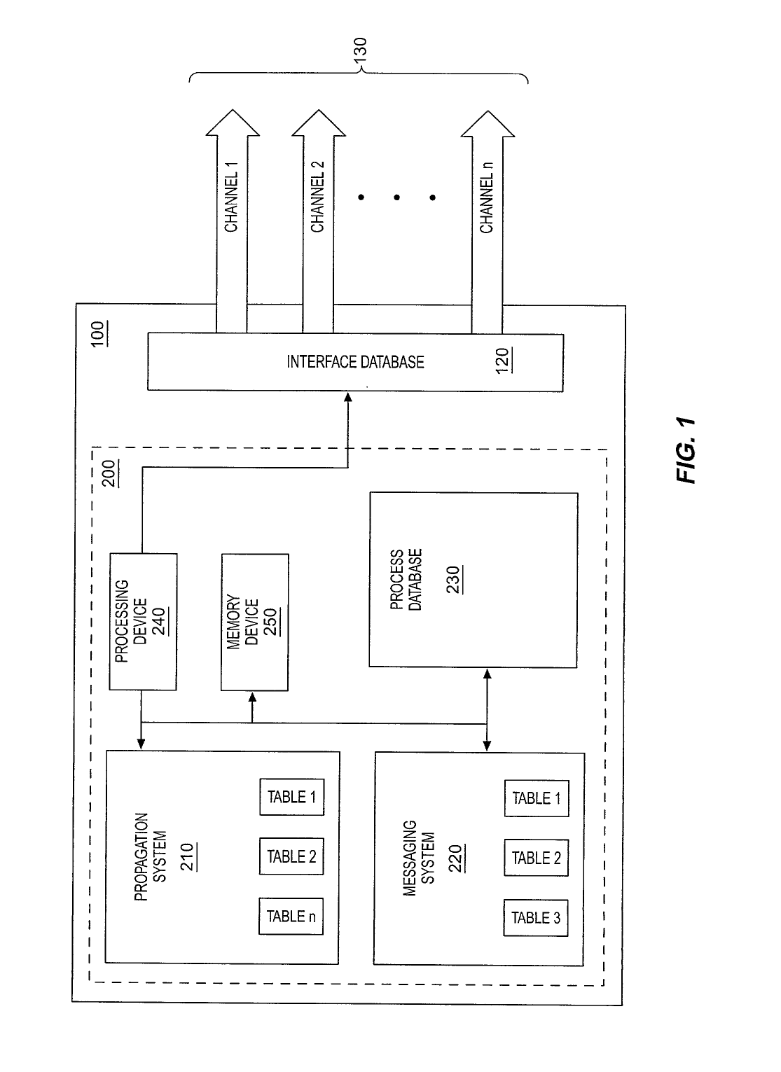

Referring to FIG. 1, the present integration messaging system 100 comprises a global link hub 200 that communicate with partners via an interface database 120 connecting to a plurality of communication protocols or channels 130. The plurality of communication protocols or channels refers to the ability of partners operating on different platforms to write to and read from global link hub 200 via interface database 120 that interfaces with a variety of communication channels 130. Subscribers to the transactions select the method of interfacing with the present integrating messaging hub 100. A business originator or a partner to the transaction can enter integration messaging system 100 via a first channel and exit the integration messaging system via an alternative second channel. Unlike prior art electronic messaging systems that require custom interface application software to communicate with the electronic messaging system, the present integration messaging system provides an apparatus and method for subscribers to easily interface with the database across disparate architectures.

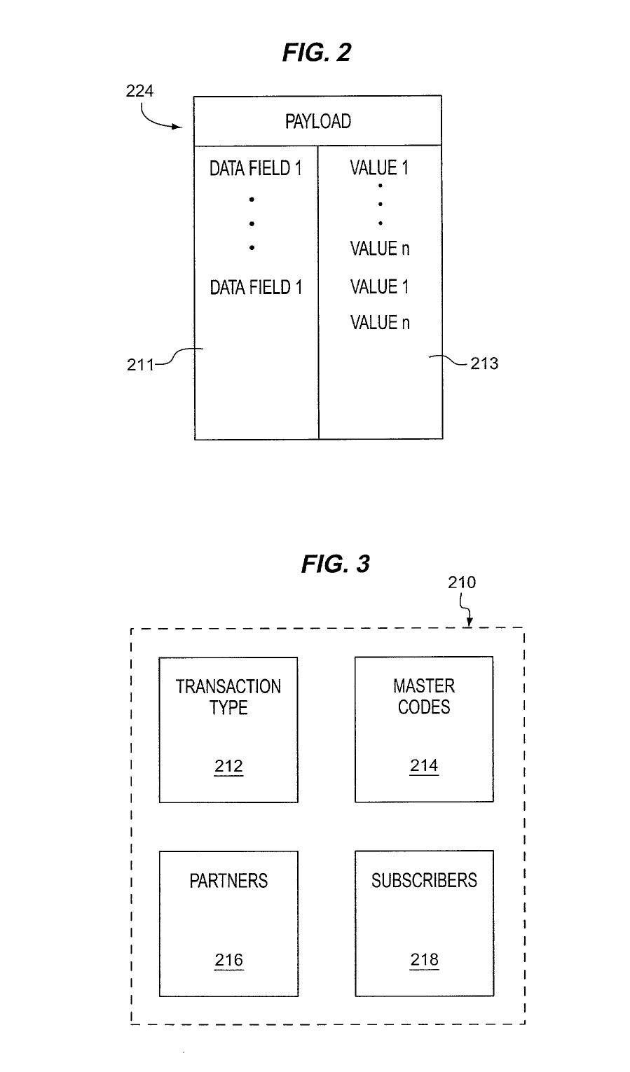

### Global Link Hub—FIG. 1 and 2:

The core of the present integration messaging system is global link hub 100 which comprises a propagation system 210, a messaging system 220, a process database 230, and processing device 240 and memory 250 associated with processing device 240. Propagation system 210 and messaging system 230 comprise a plurality of tables each having a data fields 211 and values 213 as shown in FIG. 2.

A transaction is created as a table and is customized by an originator to create a transaction template with processes associated with the transaction template. A partner table in the propagation system is comprised of a list of partners that have access to the global link hub and the subscriber table lists the subscribers associated with a particular transaction. While the tables within the propagation system are illustrated as a transaction table, master code table, partner table, and subscriber table, the propagation system can be configured with alternative tables. The table titles merely refer to the data fields that may be associated with a particular table.

Referring to FIG. 2, tables are configured with data fields and values stacked vertically rather than horizontally. Typically, horizontally stacked tables are used in spreadsheets and databases. Use of horizontal tables results in a database table that is not flexible. When a data field is added the configuration of the data base is structurally changed by adding a column to the table. Unlike horizontal tables, the vertically stacked table 224 illustrated in FIG. 2 allows additional data fields 211 and values 213 to be added to the table without requiring the core process to reconfigure the table. Instead, the vertically stacked table 224 provides a method for adding or deleting data fields 211 and values 213 by simply appending added data fields 211 or values 213 to table 224. Thus, providing a method for allowing an originator to create a customized transaction. The interrelationship of the selected data fields and associated values and triggers in conjunction with processes associated with the specific data fields provides all of the information required to process transactions.

Active transactions reside in a payload record where triggers associated with data fields within the active transaction continuously monitor the associated values searching for changes that cause the trigger to fire. Once fired, the core process searches the process database for the process associated with the trigger and executes the instructions within the associated process. A read database trigger, hereafter referred to as a trigger, monitors a specific data field for a change and is set to fire when the status of the data field is changed. Once the trigger fires, The core process searches for a process associated with the specific trigger based on the value or the transition of the value. When the associated process is located, the instructions within the process are executed to complete that portion of the transaction. Providing triggers that continuously monitor the active transaction for changes associated with the specific data fields and a core process that locates and executes a process associated with the particular trigger provides a method for the transaction originator to create customized transactions.

### Interfacing with the Integration messaging system—FIG. 1:

Unlike prior art messaging systems that required partners to interface via a customized interface application software, the present integration messaging system provides a method for partners to access the present integration messaging system via alternative protocols or channels communicating with an interface database. Since almost all large-scale applications include a databases as their “back end”, an interface database on the “front end” of the present integration messaging system simplifies talking to the global link hub. The present integration messaging system is surrounded with alternative communication channels connected to the interface database so that businesses and partners can use alternative technology to read data from and write data to the tables within the global link hub. Thus, allowing businesses that operate on a variety of disparate platforms to access, send and receive transactions electronically, leveling the playing field between large, medium and small business.

Large businesses creating and completing transactions within global link hub 200 using the present integration messaging system 100 can initiate transactions, have the transactions sent to subscribers operating on a variety of platforms, and receive completed transaction from the partners; all completed electronically. Likewise, medium and small business have the same advantage of utilizing the present integration messaging system to initiate and complete electronic business transactions. Thus, allowing businesses of all sizes, operating on different platforms, and that have disparate and often times non-existent IT infrastructures to realize the cost savings and business efficiencies through implementation of electronic business communication via the present integration messaging system.

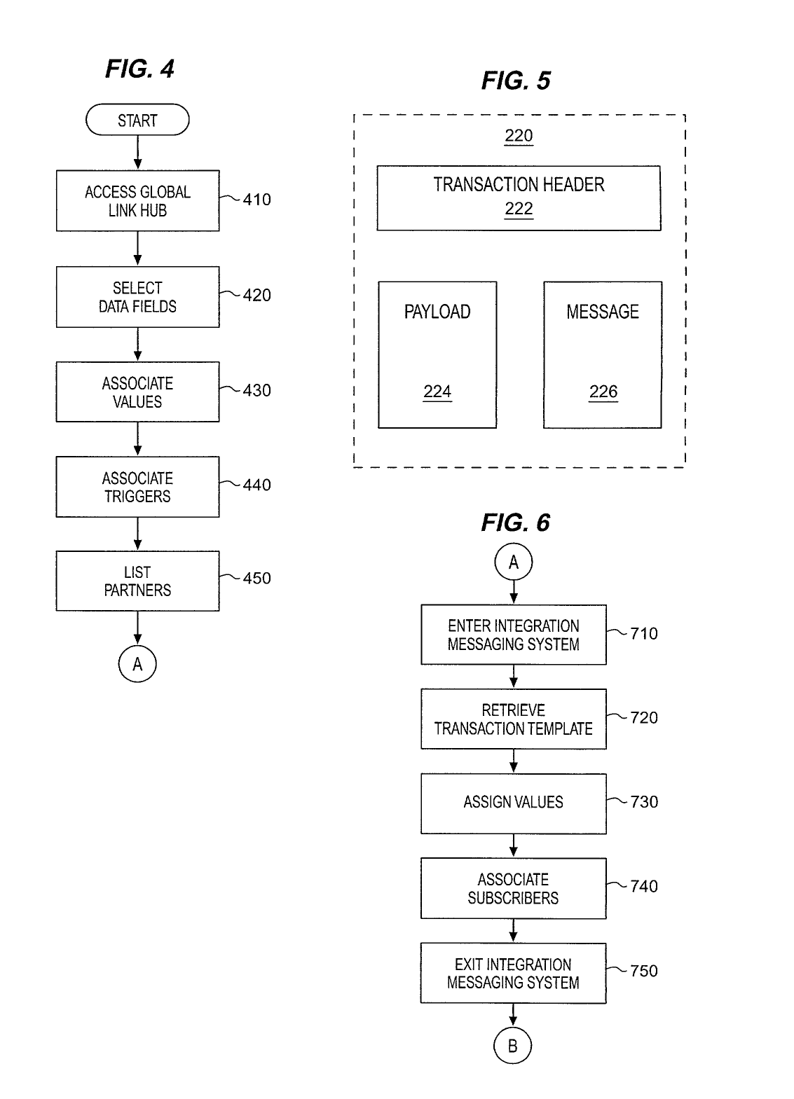

### Creating a Transaction—FIGS. 3 and 4:

Referring to FIG. 3, for purpose of illustration, a propagation system 210 comprising four tables is used to discuss the creation of a transaction template using the present integration messaging system. The four tables include a transaction type table 212, master code table 214, a partner and a subscriber tables 216 and 218 respectively. An integration messaging system comprising four tables is not intended as a limitation, those skilled in the art will appreciate that alternative numbers and types of tables can be substituted. Likewise, while the tables are illustrated and discussed comprising two columns as illustrated in FIG. 2, a vertically stacking tables including an alternative number of columns can be substituted.

A transaction template is defined by a variable number of data fields with values and triggers associated with the data fields for a specific transaction type. Referring to FIGS. 3 and 4, an originator accesses the global link hub in step 410 and creates a transaction template by inserting values into the tables within the propagation system that defines the transaction. In this example the transaction type is configured as a purchase order. Within the propagation table the originator sets transaction parameters such as whether or not a reply is required, and the time for the reply, by inserting data fields in step 420 associated with the transaction template.

Values are associated in step 430 with the data fields inserted in step 420. The originator inserts the number and the variety of values that are associated with a specific data field. The originator also associates one or more triggers with a specific data field in step 440. A trigger is associated with the specific data field to initiate a predetermined process to execute when the value associated with the specific data field changes to a predetermined value or when the value transitions from one predetermined value to another predetermined value. For example, a data field within the purchase order transaction payload table may be “Message complete?” If the value associated with the data field transitions from “no” to “yes”, a trigger monitoring the active purchase order transaction is fired and the core process locates the process associated with the data field “Message complete?.” A series of predefined processes residing within a process database in the global link hub are associated with the data field. The process is selected based on the data field and transition of the value within the data field from “0” to “1”. Another process associated with the data field is initiated when the value transitions from “0” to “2”.

The transaction originator also defines the partners that are authorized to access the information, or that will be sent a transaction of the particular type. Initially, when the particular transaction is created, a list of partners that the originator deals with is compiled into a partner list in step 450. In this example, the transaction type is a purchase order. The transaction originator's partner list includes all of the individuals or businesses that the transaction originator typically purchases goods or services from.

Once a transaction type has been created, the particular transaction is available for future use. Once a simple transaction has been created using the present integration messaging system, a more complex transaction can be created following the same steps. Each transaction using the transaction template just created, merely requires that the transaction is assigned a unique transaction designator, at least one partner is associated as a subscriber, and the required values associated with the data fields are completed.

Providing tables that allow the originator to insert data fields in step 420 to associate with the transaction template and to select one or more values in step 430 and triggers in step 440 to associate with each data field allows the originator to create customized transactions. Thus, the present integration messaging system is not structured, as are other messaging systems. Instead, the transaction originator customizes the template for each transaction type. Customizing the transaction templates eliminates the need for the business to either convert their business documents to match the electronic documents or to maintain two independent databases for completing electronic and non-electronic transactions

### Messaging System—FIG. 5:

Referring to FIG. 5, once a transaction type is defined in the propagation system, a transaction header 222 within messaging system 220 is associated with the transaction type. Within messaging header 220, a unique transaction header identification, referred to as the parent, is assigned to the associated messages. The transaction originator creates a first payload table, referred to as a child that is associated with the parent transaction header. The originator customizes the payload table following the same process of selecting data fields and associating one or more values and triggers to the data fields.

The transaction header associated with the particular transaction type is the first table to be written to. Once the transaction header table record is written to, the originator may associate one or more other table. In this example, one or more payload records 224 are written and one or more messaging records 226 can be associated with the particular transaction. For a purchase order transaction, the payload record 224 may be used by the parties to confirm quantities and prices for the particular transaction while the messaging table 226 may be used to propagate the transaction to different parties.

Each payload and message includes the unique header identification for use by the core process in associating one or more payloads to a specific payload record 224. A data field within the transaction header identifies the number of payload records associated with the transaction header.

The values within the payload comprise data relevant to completing the transaction. Each particular transaction includes as many payload records as are necessary to complete the transaction. For example, payload data fields within the messaging system payload table may include a data field for inserting a delivery schedule in response to a purchase order or a price index when the transaction type is a request for a quotation.

Thus, the present integration messaging systems provides one or more messaging records that can be associated with a particular transaction type. One or more payload records and can also be associated by including the transaction header identification to allow the parties to exchange as many messages as necessary to complete the transaction. Like the tables described for the propagation system, tables within the messaging system are also stacked vertically. As additional payloads are associated with the particular transaction, they are appended to the particular transaction.

Using the propagation system tables and the messaging systems tables associated for a transaction type, a particular transaction can be initiated by the originator.

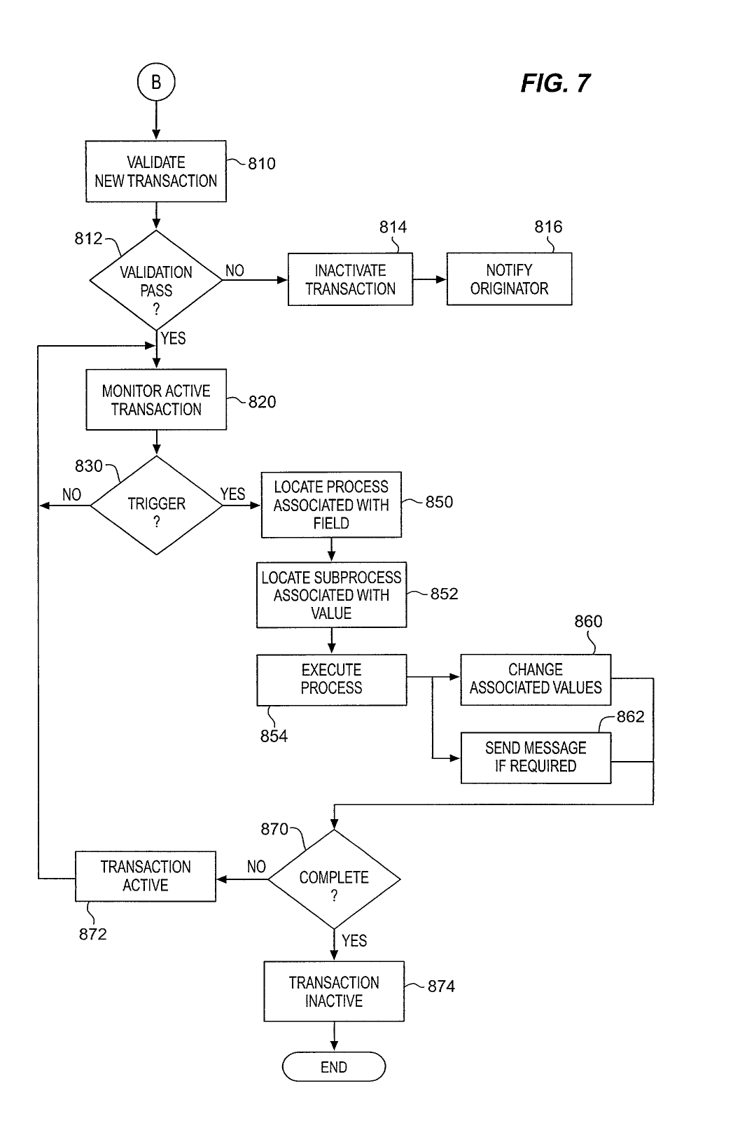

### Integration messaging system Operation—FIGS. 6 and 7:

Following the process described above for creating a transaction, an originator can create an unlimited number of transaction types for use in conducting business electronically. To illustrate the operation of the present integration messaging system, the transaction type will be a request for quotation (RFQ). Referring first to the flow diagram in FIG. 6, the originator enters the integration messaging system in step 710 and retrieves the RFQ transaction template in step 720. The originator can enter the integration messaging system using a console at the location of the server executing the transactions or by alternative methods. Providing a flexible interface to the integration messaging system allows an originator to initiate or complete a transaction from a location other than the site at which the server is located and without requiring the alternative site to have a customized interface software.

After the RFQ transaction template is retrieved, a unique transaction header identification is assigned to the transaction and the transaction becomes a standalone RFQ transaction. The originator inserts values into the data fields in step 730. In this example, the originator may specify the quantity of products required or may specify a delivery schedule. Using the previously created list of partners, subscribers to the RFQ transaction are selected in step 740. After the values are inserted in step 730 and the subscribers are associated in step 740; the originator exits the RFQ transaction and the integration messaging system.

When the originator initiates the RFQ transaction, the originator exits the system and the core process validates the information inserted. If the validation fails, the transaction is tagged inactive and stored based on a separate database index so that the core process is not required to scroll through active and inactive transactions. When the transaction is tagged inactive, the console and all other interfaces to the hub will reflect the state of the transaction.

Referring to the operational flow diagram in FIG. 7, completion of the initial process to create an RFQ transaction in the global link hub triggers the core process to first validate the transaction. Using a validation process the RFQ is validated in step 810. If the validation does not pass, in decision block 812 the RFQ transaction is assigned as inactive in step 814 and a notice is transmitted based on the configuration held in the database in step 816. If the RFQ transaction passes validation in decision step 812 the active RFQ transaction is added to the payload table and the core process searches the active RFQ transaction to determine what to do with the transaction. First, a message is transmitted to the subscribers of the RFQ transaction notifying the subscribers that they have a message in the global link hub.

The core process residing within the process database continuously searches for required actions based on triggers associated within the database in step 820. When a value changes firing a trigger in block 830, the core process searches the process database in step 850 to locate a process associated with the data field associated with the changed value. A sub-process associated with the value or transition of the value is located in step 852 and the sub-process is executed in step 854. If instructions within the sub-process require values within the transaction to be changed or a message to be transmitted, the instruction is completed in step 860 or 862, respectively. In this example, the process may send a message to the originator informing the originator that a subscriber submitted a quotation.

The core process continues to search for required actions based on triggers in step 820 including new messages or a change indicating that the transaction is complete. If the trigger that is fired in step 830 indicates that a new message has been associated with the transaction, the messaging process is located in step 850 and executed in step 854. If the message was a quotation from a subscriber, a trigger may fire within the payload database and the process associated with the data field that caused the trigger to fire may requiring a message be sent to the originator. If all of the subscribers have responded to the RFQ transaction, the RFQ transaction is flagged complete in block 860, decision block 870 triggers a transaction complete process and the RFQ transaction is changed to an inactive status in block 874 and stored in an inactive state for future reference. If the transaction is not complete in decision block 870, the transaction is tagged active in block 872 and the core process continues to monitor the active transaction.

Thus, the present integration messaging system provides a method for transaction originators and business partners to communicate and complete transactions electronically without the investing a large amount of capital into a customized interface software application or to create a process that is compatible with the messaging system solution. Instead, the present integration messaging system provides an apparatus and a method for creating customized transactions and for electronically completing the transactions. Although the operational process of the present integration messaging system has been described using an RFQ transaction, alternative transactions could be substituted following the operational process flow diagram in FIG. 7.

As to alternative embodiments, those skilled in the art will appreciate that the present integration messaging system has been illustrated and discussed having specific tables with the propagation system and the messaging system, however, alternative tables can be substituted. Likewise, the tables have been illustrated and described comprising two columns although tables comprising alternative configurations could be substituted.

It is apparent that there has been described, an integration messaging system, that fully satisfies the objects, aims, and advantages set forth above. While the integration messaging system has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A messaging system comprising:
a means for interfacing two or more parties to the messaging system;
a means for creating a customized business transaction comprising a plurality of data fields including an associated plurality of values, wherein a set of the plurality of values is associated with a set of tasks; and
a means for processing the customized business transaction according to the set of tasks associated with the set of the plurality of values, wherein when one of the set of the plurality of values changes the processing means processes a one of the set of tasks corresponding to the one of the set of the plurality of values.

2. The messaging system of claim 1 wherein the means for interfacing comprises:
two or more communication channels; and
an interface database connected to the two or more communication channels to interface the two or more parties to the messaging system.

3. The messaging system of claim 1 wherein the means for creating a customized business transaction comprises:
a means for associating a set of data fields from a plurality of data fields with the customized business transaction; and
a means for associating a set of values from a plurality of values with the set of data fields, wherein a subset of the set of values is associated with the set of tasks.

4. The integration messaging system of claim 1, wherein the means for processing the customized business transaction comprises:
a means for continuously searching the set of the plurality of values to determine when one of the set of the plurality of values changes; and
a means for processing one of the set of tasks corresponding to the one of the set of the plurality of values that changed.

5. The integration messaging system of claim 1 wherein the means for creating a customized business transaction further comprises:
at least one transaction table including a plurality of transaction data fields and a plurality of transaction values and one of the two or more parties inserts a set of transaction data fields from the plurality of transaction data fields and associates a set of transaction values from the plurality of transaction values to the set of transaction data fields to create the customized business transaction;
at least one message including a plurality of messaging data fields and a plurality of messaging values and one of the two or more parties inserts a set of messaging data fields from the plurality of messaging data fields and associates a set of messaging values from the plurality of messaging values to the set of messaging data fields, wherein the at least one message is associated with the customized business transaction; and
a means for associating a subset of the set of tasks to a subset of the set of messaging values.

6. The messaging system of claim 5, further comprising:
a means for appending two or more messages to the customized business transaction, wherein a designator is assigned to the customized business transaction and to the two or more messages to associate the two or more messages with the customized business transaction.

7. An integration messaging system for creating and processing a customized business transaction, the system comprising:
an interface database including two or more channels for accessing the integration messaging system;
a global link hub comprising a plurality of tables having a plurality of data fields corresponding to a plurality of transaction parameters and a plurality of values, wherein a set of values from the plurality of values is associated with a set of data fields from the plurality of data fields to create the customized business transaction;
a process table including a core process and a plurality of processes, wherein a set of the plurality of processes corresponds to a subset of the set of values; and
a processing means to execute the core process to monitor the subset of the set of values and to execute one of the set of the plurality of process corresponding to one of the subset of the set of values when the one of the subset of the set of values changes.

8. The integration messaging system of claim 7 wherein the global link hub comprises:
one or more transaction tables including a plurality of transaction values associated with a plurality of transaction data fields for creating the customized business transaction;
one or more messages associated with the customized business transaction, the one or more messages including a plurality of messaging values associated with a plurality of messaging data fields and the set of the plurality of processes is associated with a set of the plurality of messaging values.

9. The integration messaging system of claim 8 further comprising:
a means for assigning a designator to the customized business transaction and to the one or more messages to associate the one or more messages with the customized business transaction.

10. A customized business transaction comprising:
one or more transaction tables including a plurality of transaction values associated with a plurality of transaction data fields for creating a customized business transaction;
a message including a plurality of messaging values associated with a plurality of messaging data fields and a set of processes associated with a set of the plurality of messaging values to create the message to associate with the customized business transaction for sending and receiving a response.

11. The customized business transaction of claim 10 further comprising:
two or more new messages appended to the customized business transaction for sending and receiving two or more responses; and
a means for assigning a transaction number to the customized business transaction and to the two or more new messages to associate the two or more new messages with the customized business transaction.

12. A method for implementing the customized business transaction of claim 10, the method comprising:
a process table including a core process and the set of processes corresponding to the set of the plurality of messaging values; and
a processing means to execute the core process to monitor the set of the plurality of messaging values associated with the set of processes and to execute one or more of the set of process corresponding to one or more the set of the plurality of messaging values when the one or more of the set of messaging values changes.

13. An integration messaging system for completing a transaction between an originator and one or more subscribers, comprising:
an interface to interconnect the originator and the one or more subscribers to the integration messaging system via a plurality of communication channels;
a global link hub comprising:
a propagation system comprising a plurality of transaction tables, the plurality of transaction tables having a plurality of transaction data fields and a plurality of transaction values wherein the originator inserts a set of transaction data fields from the plurality of data fields and a set of transaction values from the plurality of transaction values; and
a messaging system comprising a plurality of messaging tables, the plurality of messaging tables having a plurality of messaging data fields and a plurality of messaging values wherein the originator or the one or more subscribers inserts a set of messaging data fields from the plurality of data fields and a set of messaging values from the plurality of messaging values for sending one or more messages;
a process database comprising a core process and a plurality of processes associated with a subset of the set of propagation values and a subset of the set of messaging values;
a processing means to execute the core process and to execute the plurality of processes;
a plurality of initiators associated with the subset of the set of propagation values and the subset of the set of messaging values, wherein when the originator or one of the one or more subscribers changes one of the subset of the set of propagation values or one of the subset of the set of messaging values one of the plurality of initiators corresponding to the one of the subset of the set of propagation values or the subset of the set of messaging values initiates the core process to execute a one of the plurality of processes corresponding to the one of the subset of the set of propagation values or the subset of the set of messaging values that changed.

14. A method of transacting electronically using an integration messaging system, the method comprising:
accessing the integration messaging system via one of a plurality of channels;
creating a customized business transaction having a plurality of values associated with a plurality of data fields wherein a set of the plurality of values are associated with a set of processes;
processing the customized business transaction according to the set of processes, wherein when one or more of the set of the plurality of values changes a corresponding one or more of the set of processes is executed.

15. The method of claim 14, wherein accessing the integration messaging system comprises:
connecting to an interface database within the messaging system via a common protocol.

16. The method of claim 14, wherein creating a customized business transaction comprises:
creating a transaction table comprising a set of transaction values associated with a set of transaction data fields; and
creating one or more messages comprising a set of messaging values associated with a set of messaging data fields wherein a subset of the set of messaging values are associated with the set of processes.

17. The method of claim 14, wherein processing the customized business transaction comprises:
inserting or changing a data in one or more of the set of the plurality of values;
searching the customized business transaction for a change in one or more of the set of the plurality of values; and
processing one or more of the set of processes corresponding to the one or more of the set of the plurality of values in which the data was inserted or changed.

18. A method of creating a customized transaction using an integration messaging system comprising two or more tables having a plurality of data fields and a plurality of values and a set of tasks, the method comprising:
accessing the integration messaging system;
inserting a set of data fields from the plurality of data fields into at least one of the two or more tables;
associating a set of values from the plurality of values with the set of data fields wherein a subset of the set of values are associated with a subset of the set of tasks; and
associating at least one subscriber to the customized transaction, wherein when the customized transaction is processed the subscriber accesses the customized transaction using the integration messaging system.
